(19) United States
(12) Patent Application Publication
(10) Pub. No.: US 2010/0127090 A1
(43) Pub. Date: May 27, 2010

(54) ENERGY RECYCLING

(75) Inventors: Jonas Tornblom, Stockholm (SE); Tord Ringenhall, Ekero (SE); Goran Eriksson, Stockholm (SE)

Correspondence Address: YOUNG & THOMPSON, 209 Madison Street, Suite 500, Alexandria, VA, 22314, US

(73) Assignee: ENVAC AB, Stockholm (SE)

(21) Appl. No.: 12/528,517

(22) PCT Filed: Jan. 31, 2008
(86) PCT No.: PCT/SE2008/050127

§ 371 Date: Aug. 25, 2009

(30) Foreign Application Priority Data
Mar. 8, 2007 (SE) 0700576-2

(51) Int. Cl. F24J 3/00; F28D 15/00; B65F 5/00

(52) U.S. Cl. 237/1 R; 165/104.11; 237/81

(57) ABSTRACT

In a waste collection system where deposited waste is transported by partial vacuum in transport pipes (2) leading from spaced collection points to a central collection station (4) containing a system vacuum source (5) including at least one vacuum-producing machine (6), thermal energy is extracted from a vacuum-producing machine exhaust air stream (EAS), is transferred to a fluid medium and is used for heating or cooling purposes in a specific residential area where the deposited and transported waste is generated.

### TECHNICAL FIELD

The present invention generally concerns waste management and more specifically relates to waste collection systems wherein vacuum pressure is employed to suck waste from a waste deposit point to a central waste collection central.

### BACKGROUND

Vacuum operated waste collection systems of a stationary type are quite commonly used for collecting mainly domestic or office waste in residential or business areas, but also for collecting hospital waste etc. In such systems, deposited waste is sucked in sequence from separate spaced deposit or collection points to a central collection station. The collection points are spaced apart by considerable distances and are connected to the collection station by a pipe system. Due to the considerable transport distances, at least for waste from the most distant collection points, a comparatively powerful vacuum is required to securely convey the deposited waste without blockage from the respective collection points to the collection station.

The powerful vacuum is created by a number of vacuum-producing machines whose number varies with the dimension as well as the complexity of the waste collection system and with the distances of the collection points from the collection station. The energy consumption of these vacuum-producing machines is large, which negatively affects the cost efficiency of the entire waste collection system. This large energy consumption is also undesirable from a general environmental point of view.

Attempts have been made throughout the years to lower the energy consumption of the vacuum-producing machines that are by far the major energy consumers of the entire systems. One approach has been to shorten the active periods of the vacuum-producing machines. However, with the continuously increasing volumes of waste produced and with the tendency towards waste collection systems serving larger residential, office or other areas, the required capacity of the vacuum-producing machines rather tends to increase instead. In theory, alternative solutions would be to reduce the system volume by using a smaller diameter for the transport pipe system or to lower the generated vacuum pressure. In practice such solutions are unacceptable since they dramatically increase the sensitive of the system for plug formation and blockage in the pipe system.

### SUMMARY

It is a general object of the present invention to provide improvements for vacuum operated waste collection systems by reducing the amount of energy wasted in the systems.

In particular it is an object of the invention to suggest a method of recovering and recycling energy consumed by the vacuum-producing machines of vacuum waste collection systems.

In particular it is a further object of the invention to provide an energy recovery and recycling system adapted for performing the method of the invention.

These and other objects are met by the invention as defined by the accompanying patent claims.

The invention generally relates to waste collection systems of the kind wherein deposited waste is transported by partial vacuum in transport pipes leading from spaced collection points to a central collection station. The station contains a system vacuum source consisting of at least one vacuum-producing machine. In such a system, a considerable reduction of the amount of energy wasted in the system is achieved by extracting thermal energy from a vacuum-producing machine exhaust air stream, by returning the extracted thermal energy to a specific area from which the waste is collected and by using the so extracted thermal energy for heating or cooling purposes in the specified area, thereby providing a very effective recycling of the consumed and otherwise wasted energy to the specified area as well as a reduction of the local environmental load of the collection system. This will increase the cost-efficiency as well as the environmental friendliness of the system.

In accordance with a further aspect of the invention, this is applied to waste collection systems where an activated carbon type odour filter unit is provided in the exhaust air stream. In accordance with this aspect, the thermal energy is extracted upstream of the activated carbon filter unit, thereby increasing the efficiency as well as the useful life of the filter unit by lowering the air temperature.

In embodiments of the invention, heat is retracted by conducting the exhaust air stream through a heat exchanger or alternatively a heat collector prior to exhausting said air stream into the atmosphere.

In another embodiment, heated fluid medium from the heat exchanger/heat collector is used specifically to supply heat to a heating system and/or a tap water system for said specified area.

In another embodiment, the heated fluid medium is used to supply heat to a district heating network.

Preferred further developments of the basic inventive idea as well as embodiments thereof are specified in the dependent subclaims.

Advantages offered by the present invention, in addition to those described above, will be readily appreciated upon reading the below detailed description of embodiments of the invention.

### BRIEF DESCRIPTION OF THE DRAWINGS

The invention, together with further objects and advantages thereof, will be best understood by reference to the following description taken together with the accompanying drawings, in which:

FIG. 1 is a schematical illustration of a generic waste collection system for managing waste generated in a specified residential area;

FIG. 2 is a schematical illustration, partly in section, and in greater detail, of parts of the waste collection system of FIG. 1;

FIG. 3 is a schematical illustration of an embodiment of a thermal energy recovery system according to the invention;

FIG. 4 is a schematical illustration of an installation for recycling thermal energy recovered by the heat recovery system of FIG. 3;

FIG. 5 is a schematical illustration of an alternative installation for recycling thermal energy recovered by the heat recovery system of FIG. 3; and

FIG. 6 is a partly schematical, sectioned view of an embodiment of a combined filter and heat exchanger container for use in the thermal energy recovery system of the invention.

### DETAILED DESCRIPTION

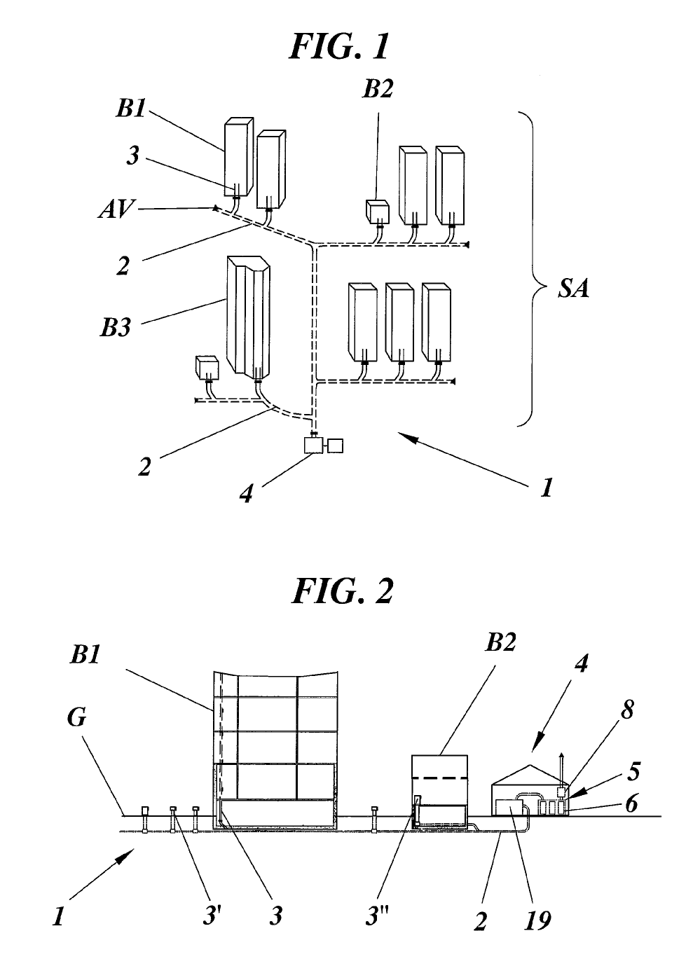

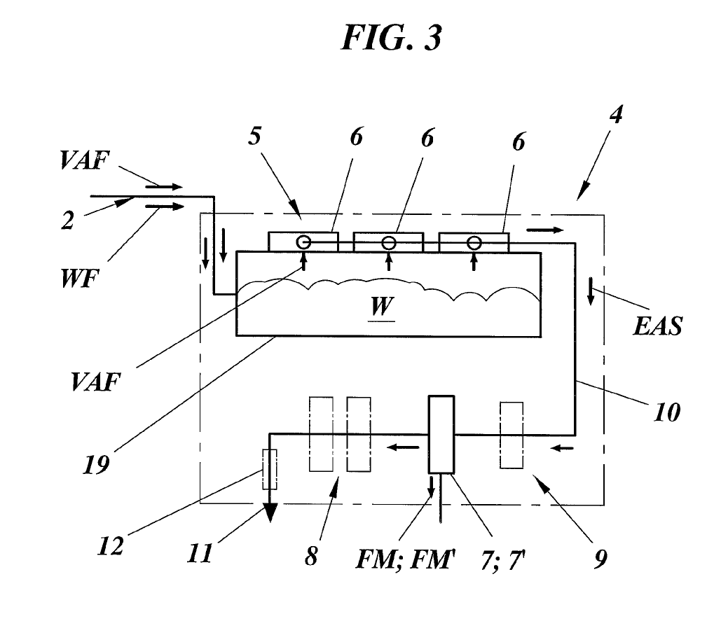

The invention will now be explained with reference to exemplifying embodiments of a thermal energy recovery and recycling system of the invention that are illustrated in the accompanying drawing figures. The exemplifying embodiments of the invention are illustrated in FIGS. 3-6, and relate to an application of the inventive solution to a vacuum waste collection system 1 of a stationary type that is partially and schematically outlined in FIGS. 1 and 2. It shall be emphasized, though that the illustrations are for the purpose of describing preferred embodiments of the invention and are not intended to limit the invention to the details thereof.

FIGS. 1 and 2 illustrate an example of a conventional vacuum waste collection system 1 of a stationary type serving a specified residential area SA. Waste is deposited at waste collection points 3, 3′ or 3″ (see FIG. 2) in or outside buildings B1-B3 of the area SA. For further details regarding different kinds of waste deposit or collection points, reference is made e.g. to our European Patent No. EP 1 401 742 B1. The deposited waste is sequentially emptied from the collection points 3, 3′ or 3″ through a transport pipe system 2 laid under ground G. Specifically, the collected waste is sucked from the collection points 3, 3′, 3″ to a waste container 19 in a central waste collection station 4 by a strong vacuum generated by a vacuum source 5 in said station 4. The vacuum source 5 contains a number of vacuum-producing machines 6 that in the illustrated embodiments are series connected vacuum fans that are operated by electrical motors (not specifically illustrated). It should be emphasized though, that the invention is not restricted to the use of vacuum fans as vacuum-producing machines 6. In other waste collection applications where the invention may be successfully used, the vacuum-producing machines may instead be turbines or pumps. The number of vacuum-producing machines used is adapted to the size and complexity of the system 1 and also to the expected waste volumes and waste composition.

As was mentioned in the introduction, the process of generating the powerful vacuum required to allow secure transport of collected waste from collection points 3, 3′, 3″ to the station 4 is very energy-consuming. On the one hand, there are energy losses in the drive motors for the vacuum-producing machines. In applications with vacuum fans, the energy efficiency of the drive motors is in the order of 80%. However, it has been recognized that in addition to these energy losses a considerable part of the energy supplied to the vacuum-producing machines is transformed into heat. To be precise, the subatmospheric pressure and air flow produced by the vacuum-producing machines is to a very large extent converted into heat in the pressure rise across the machines. In fact, in practical applications as much as approximately 70% of the total energy supplied to the vacuum-producing machines is converted into heat. This heat or thermal energy has heretofore been wasted by simply being discharged into the atmosphere with the exhaust air stream. The so wasted energy markedly deteriorates the cost efficiency of the overall system and is also a factor to be considered when evaluating the environmental load generated by the system.

In larger and heavily loaded waste collection systems 1 several powerful vacuum-producing machines 6, three or more, may be operated between 5-10 hours a day to securely empty all the waste W deposited at the different, spaced collection points 3, 3′, 3″. Conducted experiments and calculations have now revealed that in a waste collection system utilizing three vacuum fans 6 to produce the required vacuum pressure and air flow, thermal energy in the order of 220 kW may be discharged into the atmosphere with the vacuum fan exhaust air and thereby wasted. Such wasted energy will also cause a considerable local environmental load.

It has now been realized that essentially improved cost efficiency of the overall waste collection system 1 as well as general and local environmental benefits may be achieved by recovering the heat of exhaust air from the vacuum-producing machines 6 prior to its discharge into the atmosphere and by recycling said heat or thermal energy for heating or cooling purposes.

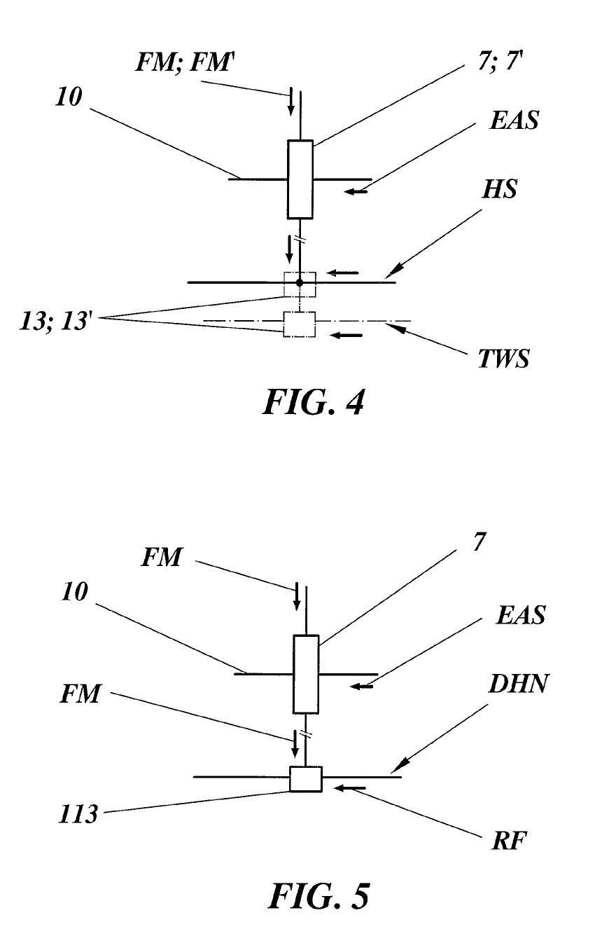

An embodiment of an energy recovery and recycling system as suggested according to the invention will now be described in greater detail with reference to FIGS. 3 and 4. The energy recovery and recycling system is integrated in a waste collection system 1 of the general type described above. When emptying waste W deposited at a separate waste collection point 3, 3′, 3″ or in an entire branch of the system 1, the vacuum fans 6 (three fans in the exemplary system 1) of the system vacuum source 5 are activated to create the required vacuum pressure. Then, a respective air inlet valve AV (see FIG. 1), and in the relevant case the respective branch valve (not shown), is opened to create a vacuum air flow VAF through the pipe system 2. This partial vacuum in turn creates a waste flow WF from the respective part of the system 1 towards the collection station 4.

The vacuum air flow VAF and the waste flow WF enter the waste container 19 where the waste W is separated from the air flow VAF and is collected. The separated vacuum air flow VAF enters the fans 6 and is heated by the fan parts acquiring considerable heat from the vacuum generating work thereof. This heated vacuum fan exhaust air stream EAS is conducted from the fans 6, through a vacuum fan exhaust air pipe system 10 and in most cases through a silencer 12, and is discharged into the atmosphere through a vacuum fan exhaust air outlet 11.

In one embodiment of the thermal energy recovery and recycling system of the invention a heat exchanger 7 is provided in the vacuum fan exhaust air pipe system 10 to recover a major part of the heat contained in the vacuum fan exhaust air stream EAS. The heat exchanger contains a fluid medium FM to which the heat of the vacuum fan exhaust air stream EAS is transferred and that is connected directly or indirectly to a heating system HS and/or to a tap water system TWS of the specified area SA, for recovering and recycling otherwise wasted heat by returning it to the specified area for heating purposes. In other words, the heat exchanger 7 fluid medium FM may consist of the actual fluid medium of said heating system HS and/or tap water system TWS or may be in heat transferring contact therewith through a further heat exchanger 13 illustrated in FIG. 4.

In an alternative embodiment of the heat recovery and recycling system of the invention a heat collector 13′ is provided in the vacuum fan exhaust air pipe system 10 and contains a collector fluid medium FM′ to be heated by the vacuum fan exhaust air stream EAS. In this case said heated collector fluid medium FM′ is likewise connected to a heating system HS and/or to a tap water system TWS of the specified area SA for transferring heat thereto. Preferably, the heated collector fluid medium FM′ is thereby conveyed to a heat pump 13′ delivering heat to the heating system/tap water system, as is likewise indicated in FIG. 4.

In this described embodiment of the invention the recovered heat is recycled to the specified area SA from which the waste W has been collected. In other words, this embodiment of the invention suggests that the collection of waste in a first direction from the specified area SA to the collection central 4 is supplemented by a recycling of heat recovered from the fan exhaust air in an opposite direction, back to the specified area SA for heating purposes. The general environmental benefits consist in the lowering of the thermal energy consumption of the specified area and the immediate local environmental benefits consist in the considerable reduction of the temperature of the discharged fan exhaust air.

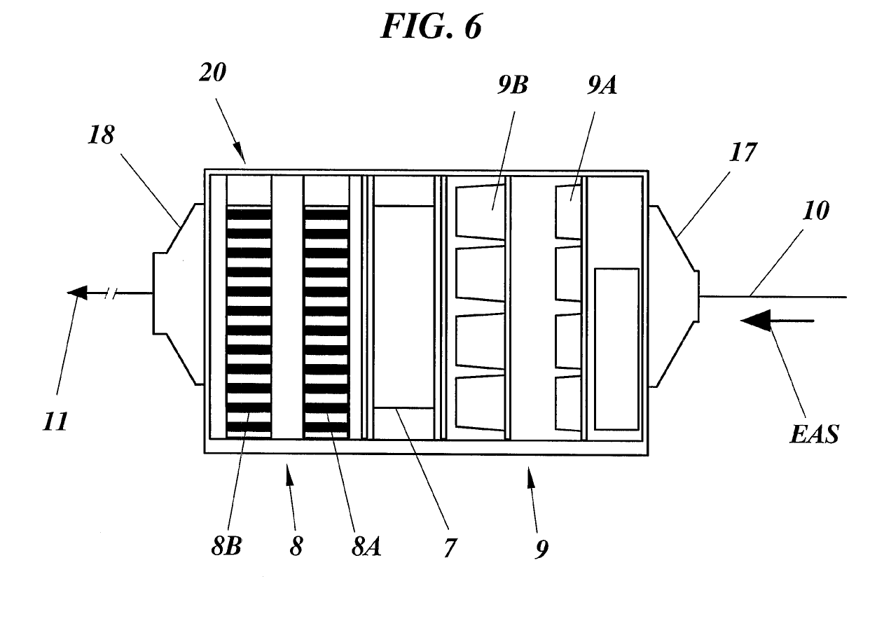

In most waste collection systems 1 the waste collection station 4 comprises an odour removal filter unit 8, such as filters 8A, 8B shown in FIG. 6, for filtering the fan exhaust air stream EAS from the system vacuum source 5 prior to exhausting said air stream into the atmosphere. Such odour filters are often required for sanitary reasons. It has now been realized that in such systems using odour removal filter units having activated carbon type filters, the suggested heat recovery system will provide additional advantages when the heat exchanger or heat collector 7 and 7′, respectively, is provided in the fan exhaust stream EAS upstream of the activated carbon type filter unit 8. The resulting lowering of the temperature of the air entering the filter unit 8 will not only improve the odour-eating effect of the filter unit 8 but will also extend its useful life. The latter fact is not negligible since it will reduce the normally very high running expenses for exchanging the activated carbon of the filter.

Preferably, the system also contains a dust and particle filter unit 9 that is provided in the exhaust air stream EAS upstream of the heat exchanger/heat collector 7, 7′ to prevent fouling of the heat exchanger or heat collector surfaces and thereby to maintain good heat transfer characteristics thereof, even after prolonged use.

In accordance with the invention, the suggested exemplifying thermal energy recovery and recycling method therefore involves the steps of extracting wasted thermal energy from the vacuum fan exhaust air stream EAS, then transferring the extracted thermal energy to a fluid medium FM; FM′ and recycling said heated fluid medium directly or indirectly for heating purposes in the specified area SA.

As mentioned above, the inventive thermal energy recovery and recycling method may advantageously be applied in a waste collection system 1 wherein the exhaust air stream EAS from the system vacuum source 5 of the waste collection station 4 is filtered by an activated carbon type odour removal filter unit 8 prior to exhausting said air stream into the atmosphere. By extracting thermal energy from the vacuum fan exhaust air stream EAS upstream of such a filter unit 8, the above described additional benefits of the invention are achieved.

Conducting the fan exhaust air stream EAS from the vacuum fan or fans 6 through a heat exchanger 7 or alternatively through a heat collector 7 prior to exhausting said air stream EAS into the atmosphere, will not only provide the desired energy recovery therefrom, but will likewise result in the discussed significant reduction of the environmental load caused by the discharge of overheated exhaust air.

Although the use of the heated fluid medium FM to recycle thermal energy to a heating system HS and/or a tap water system TWS for said specified area SA, will not lower the energy consumption of the actual waste collection system 1, the recovery of the heat and its recycling to the area will thus be a very significant factor not only when regarding the cost efficiency of the waste collection system 1 but also when regarding this entire area from an environmental point of view.

These beneficial effects will be obtained whether the heated fluid medium FM from a heat exchanger is used directly or indirectly (through the above mentioned further heat exchanger 13) in the heating system HS and/or in the tap water system TWS for the specified area SA, or the heated fluid medium from a heat collector 7′ is conducted to a heat pump 13′ delivering heat to the heating system HS and/or tap water system TWS of the area SA.

FIG. 6 illustrates an exemplary embodiment of a combined filter and heat exchanger container 20 suitable for use in the inventive heat recovery and recycling system. At one end, the container 20 has an inlet 17 to which the vacuum fan exhaust air pipe system 10 is connected to conduct the exhaust gas stream EAS first through a dust and particle filter unit 9 that in this embodiment comprises two series connected filters 9A, 9B. Downstream of the filter unit 9 is provided a heat exchanger 7 receiving the hot and now clean exhaust air stream EAS for heat extraction therefrom. Behind the heat exchanger is then installed an odour removal filter unit 8 containing two series connected activated carbon filters 8A and 8B that will be supplied with the now considerably cooler exhaust air stream EAS, thereby significantly improving the effect of the carbon filters. The now practically odour free exhaust air stream EAS then leaves the container 20 through an outlet 18 and is discharged through the vacuum fan exhaust air outlet 11.

In an alternative to the above described embodiment, the basic principles of the invention may be applied to provide the same benefits by supplying the recovered thermal energy to a district heating network DHN, as indicated very schematically in FIG. 5, or to similar centralized heating utilities. In such an application the fluid medium FM heated by the vacuum-producing machine exhaust air stream EAS is preferably used to preheat the return flow RF of the district heating network DUN through an appropriate heat exchanging device 113.

The inventive energy recovery and recycling principles may also with great advantage be used in applications where there is already an existing heat pump system, possibly in combination with e.g. ground source heat and/or solar heat installations, to maximize and thereby optimize the use of the heat pump of such installations.

Although the invention has been described and illustrated with specific reference to an application for a specific residential area, the invention is in no way restricted to such applications. The basic principles of the invention may be applied to provide the same energy recovery, environmental and recycling benefits in waste collection systems intended for office, business and hospital areas etc.

Furthermore, the above discussed exemplifying embodiments of the invention all relate to the use of the recovered thermal energy in a heating utility, such as the described heating system HS and/or tap water system TWS or district heating network DUN. It should therefore be emphasized, that the present invention is not restricted to such a use of the recovered thermal energy for heating purposes but likewise covers applications where the recovered thermal energy is used for cooling purposes by being supplied to a cooling utility. Techniques are known, whereby heat is transferred into cold through sorption, even without the use of cold media or compressors.

The invention has been described in connection with what is presently considered the most practical and preferred embodiments, but it is to be understood that the invention is not limited to the disclosed embodiments. The invention is therefore intended to cover various modifications and equivalent arrangements included within the spirit and scope of the appended claims.

1. A method of recovering and recycling energy from a waste collection system (1) where waste (W) is transported by partial vacuum in transport pipes (2) leading from spaced collection points (3; 3′, 3″) to a central collection station (4) containing a system vacuum source (5) consisting of at least one vacuum-producing machine (6), characterized by:
using the partial vacuum, in a manner known per se, for transporting waste generated in and deposited at waste collection points (3; 3′, 3″) in or outside buildings (B1-B3) of a specific residential area (SA);
recovering thermal energy from the part of the total energy supplied to the vacuum-producing machine (machines) that is transferred into heat, by
extracting thermal energy from a vacuum-producing machine exhaust air stream (EAS) prior to exhausting said air stream into the atmosphere;
transferring the extracted thermal energy to a fluid medium (FM; FM′); and
using said heated fluid medium in heating or alternatively cooling utilities in the specific residential area (SA).

2. A method according to claim 1, characterized by using said heated fluid medium (FM) directly in a heating system (HS) and/or a tap water system (TWS) for said specific residential area (SA).

3. A method according to claim 1, characterized by using said heated fluid medium (FM; FM′) to indirectly supply heat to a heating system (HS) and/or a tap water system (TWS) for said specific residential area (SA).

4. A method according to claim 1 characterized by conducting the vacuum-producing machine exhaust air stream (EAS) through a heat exchanger (7) prior to exhausting said air stream into the atmosphere.

5. A method according to claim 1, characterized by conducting the vacuum-producing machine exhaust air stream (EAS) through a heat collector (7′) prior to exhausting said air stream into the atmosphere and by conducting the heated fluid medium (FM′) from the heat collector to a heat pump (13′) delivering heat to a heating system (HS) and/or to a tap water system (TWS) of the specific residential area (SA).

6. A method according to claim 1, for use in a waste collection system (1) wherein the exhaust air stream (EAS) from the system vacuum source (5) of the waste collection station (4) is filtered by an activated carbon type odour removal filter unit (8) prior to exhausting said air stream into the atmosphere, characterized by extracting thermal energy from the vacuum-producing machine exhaust air stream (EAS) upstream of the filter unit (8).

7. A method according to claim 1, characterized by using said heated fluid medium (FM; FM′) to supply heat to a district heating network (DHN).

8. A system for recovering and recycling energy from a waste collection system (1) where waste (W) is transported by partial vacuum in transport pipes (2) leading from spaced collection points (3, 3′, 3″) to a central collection station (4) containing a system vacuum source (5) consisting of at least one vacuum-producing machine (6), characterized in that the energy recovering and recycling system is integrated in a waste collection system, known per se, where transported waste (W) is generated in a specific residential area and is deposited at waste collection points (3, 3′, 3″) in or outside buildings (B1-B3) of the specific residential area, by an exhaust air pipe system (10) in which an exhaust air stream (EAS) from the vacuum-producing machine (machines) is conducted, by a heat exchanger (7) or alternatively a heat collector (7′) provided in the exhaust air pipe system (10) and containing a fluid medium (FM and FM′, respectively) to be heated by thermal energy from the part of the total energy supplied to the vacuum-producing machine (machines) that is transferred into heat in the vacuum-producing machine exhaust air stream (EAS) and in that said heated fluid medium (FM and FM′, respectively) is connected to a heating or alternatively to a cooling utility of the specific residential area (SA), for transferring thermal energy thereto.

9. A system according to claim 8, characterized in that said heated fluid medium (FM; FM′) is connected to a heating system (HS) and/or to a tap water system (TWS) of the specific residential area (SA) for transferring heat thereto.

10. A system according to claim 8 for use in a waste collection system (1) wherein the waste collection station (4) comprises an activated carbon type odour removal filter unit (8) for filtering the vacuum-producing machine exhaust air stream (EAS) prior to exhausting said air stream into the atmosphere, characterized in that the heat exchanger or heat collector (7 and 7′, respectively) is provided in the exhaust air stream (EAS) upstream of the odour removal filter unit (8).

11. A system according to claim 8, characterized in that the heated fluid medium (FM′) of the heat collector (7′) is conducted to a heat pump (13′) delivering heat to the heating system (HS) and/or to the tap water system (TWS) of the specific residential area (SA).

12. A system according to claim 8, characterized in that the heated fluid medium (FM; FM′) is connected to a district heating network (DHN).

13. A method according to claim 2 characterized by conducting the vacuum-producing machine exhaust air stream (EAS) through a heat exchanger (7) prior to exhausting said air stream into the atmosphere.

14. A method according to claim 3 characterized by conducting the vacuum-producing machine exhaust air stream (EAS) through a heat exchanger (7) prior to exhausting said air stream into the atmosphere.

15. A method according to claim 2, characterized by conducting the vacuum-producing machine exhaust air stream (EAS) through a heat collector (7′) prior to exhausting said air stream into the atmosphere and by conducting the heated fluid medium (FM′) from the heat collector to a heat pump (13′) delivering heat to a heating system (HS) and/or to a tap water system (TWS) of the specific residential area (SA).

16. A method according to claim 3, characterized by conducting the vacuum-producing machine exhaust air stream (EAS) through a heat collector (7′) prior to exhausting said air stream into the atmosphere and by conducting the heated fluid medium (FM′) from the heat collector to a heat pump (13′) delivering heat to a heating system (HS) and/or to a tap water system (TWS) of the specific residential area (SA).

17. A system according to claim 9 for use in a waste collection system (1) wherein the waste collection station (4) comprises an activated carbon type odour removal filter unit (8) for filtering the vacuum-producing machine exhaust air stream (EAS) prior to exhausting said air stream into the atmosphere, characterized in that the heat exchanger or heat collector (7 and 7′, respectively) is provided in the exhaust air stream (EAS) upstream of the odour removal filter unit (8).

18. A system according to claim 9, characterized in that the heated fluid medium (FM′) of the heat collector (7′) is conducted to a heat pump (13′) delivering heat to the heating system (HS) and/or to the tap water system (TWS) of the specific residential area (SA).

19. A system according to claim 10, characterized in that the heated fluid medium (FM′) of the heat collector (7′) is conducted to a heat pump (13′) delivering heat to the heating system (HS) and/or to the tap water system (TWS) of the specific residential area (SA).

20. A system according to claim 17, characterized in that the heated fluid medium (FM′) of the heat collector (7′) is conducted to a heat pump (13′) delivering heat to the heating system (HS) and/or to the tap water system (TWS) of the specific residential area (SA).
